(19) United States
(12) Patent Application Publication
(10) Pub. No.: US 2025/0204674 A1
(43) Pub. Date: Jun. 26, 2025

(54) APPARATUS FOR COUPLING TO A PUMP MECHANISM

(71) Applicant: A.T.R Solutions LLC, Greenwood, IN (US)

(72) Inventor: Karl Hudson, Greenwood, IN (US)

(73) Assignee: A.T.R Solutions LLC, Greenwood, IN (US)

(21) Appl. No.: 18/978,787

(22) Filed: Dec. 12, 2024

Related U.S. Application Data
(60) Provisional application No. 63/613,158, filed on Dec. 21, 2023.

(51) Int. Cl. A45D 40/26; A46B 15/00; B05B 15/30

(52) U.S. Cl. CPC A45D 40/265; A46B 15/0055; A46B 2200/1046; B05B 15/30

(57) ABSTRACT

The invention is an adapter designed to apply moisturizers to a child's skin without direct skin contact. Made from safe, soft silicone or a similar material, the adapter can be attached to the end of nearly any lotion bottle equipped with a pump. The hollow design of the adapter allows for normal usage of the lotion even when the adapter is attached. This invention provides a practical and efficient solution to challenges associated with lotion application, enhancing comfort for both the child and the user.

### PRIORITY

The present application is related to, and claims the priority benefit of, U.S. provisional patent application Ser. No. 63/613,158, filed Dec. 21, 2023, the contents of which are incorporated herein directly and by reference in its entirety.

### BACKGROUND

The application of lotions, creams, and moisturizers to a child's skin is a common practice undertaken by parents and caregivers. This is particularly true after bathing, when the skin is most receptive to the absorption of these substances. However, this process is not without its challenges and drawbacks.

One of the primary issues is the potential for causing discomfort or even harm to the child during the application process. The tops of lotion bottles, for instance, can be hard, dull, or even sharp. When unscrewing these tops to access the lotion, there is a risk of accidentally poking or scratching the child with the end of the top. This can cause pain and distress to the child, making the process of applying lotion an unpleasant experience for both the child and the parent or caregiver.

Another significant issue is the discomfort that can arise from skin-to-skin contact during the application process. This can be particularly problematic for individuals who have experienced traumatic events that make such contact uncomfortable or even distressing. This can make the process of applying lotion to a child's skin a difficult and emotionally taxing task.

Moreover, teaching children about body boundaries can be a challenging task. The process of applying lotion can blur these boundaries, making it difficult for children to understand and respect them. This can lead to confusion and misunderstandings, and can potentially undermine efforts to teach children about the importance of respecting personal space and boundaries.

Various solutions have been proposed to address these issues. For instance, gloves have been developed for the application of moisturizers. These gloves are designed to create a barrier between the parent or caregiver's hand and the child's skin, reducing the potential for discomfort from skin-to-skin contact. However, the use of these gloves still requires the parent or caregiver to physically touch the child during the application process.

Another proposed solution involves the use of “sticks” with an applicator. These devices are designed to dispense the lotion and apply it to the child's skin. However, these devices have their own drawbacks. For instance, they often need to be frequently refilled or have lotion reapplied to the applicator, which can be a hassle. Furthermore, the use of these devices still requires some degree of physical contact with the child, which can be problematic for the reasons outlined above.

### BRIEF SUMMARY

The present disclosure includes disclosure of innovative adapters designed for the application of lotions, creams, and moisturizers to a person's skin, such as a child's skin. They can be made of safe, soft silicone or a similar material, ensuring a gentle touch on the child's skin. The invention is designed to fit on the end of almost any lotion bottle tube that has a pump, providing a versatile solution that can be used with a wide range of products.

The adapter has a hollow passageway, allowing for normal usage of the lotion pump even when the adapter is attached. This feature provides an easy, mess-free way to apply lotions without the need for direct skin-to-skin contact. The adapter can be left attached to the lotion bottle for convenience, or it can be removed for use with another bottle.

One of the key benefits of this invention is the ability to “paint” the lotion onto the child's skin without touching them with your hands. This can be particularly beneficial for individuals who find skin-to-skin contact uncomfortable or distressing. Additionally, the use of the adapter can aid in teaching children about body parts and boundaries, as the lotion can be applied in a controlled, deliberate manner.

The invention offers several other significant benefits. It is interchangeable, fitting almost all pump-action lotion tubes, making it a versatile tool that can be used with a variety of products. The adapter is easy to create, use, and clean, providing a user-friendly solution that can be quickly integrated into daily routines. Moreover, the adapter is BPA-free and hypoallergenic, ensuring it is safe for use with children. The primary elements of the invention can include a silicone component shaped like a small basting brush, and a hollow interior that allows for the passage of lotion from the pump to the brush. This effective design provides a practical and efficient solution to the challenges associated with applying lotions to a child's skin.

The present disclosure includes disclosure of an apparatus for applying moisturizers to a child's skin without skin contact, comprising an adapter body made of safe soft silicone or similar material, shaped like a small basting brush, a hollow interior within said body, designed to allow the passage of lotion from a pump to the brush-like end of the adapter, and a means for attaching the adapter to the end of almost any lotion bottle that has a pump.

The present disclosure includes disclosure of an apparatus, wherein the adapter body remains attached to the lotion bottle during normal usage of the lotion.

The present disclosure includes disclosure of an apparatus, wherein the adapter body is made of a material that is gentle on a child's skin.

The present disclosure includes disclosure of an apparatus, wherein the adapter body is durable and easy to clean.

The present disclosure includes disclosure of an apparatus, wherein the adapter body is designed to facilitate the even distribution of lotion on a child's skin.

The present disclosure includes disclosure of an apparatus, wherein the adapter body is designed to allow the user to “paint” the lotion onto the child's skin in a controlled and deliberate manner.

The present disclosure includes disclosure of an apparatus, further comprising other silicone-like materials.

The present disclosure includes disclosure of an apparatus, further comprising dyes for color. The present disclosure includes disclosure of an apparatus, wherein the adapter body is interchangeable and can be used with a variety of lotion bottles that have a pump.

The present disclosure includes disclosure of an apparatus, wherein the adapter provides a practical and efficient solution to the challenges associated with applying lotions to a child's skin.

The present disclosure includes disclosure of an apparatus, comprising an adapter body having an upper part, a lower part, and a channel defined therethrough, wherein the upper part of the adapter body is configured to engage a pump mechanism, and wherein a lower part of the adapter body comprises a plurality of bristles extending therefrom.

The present disclosure includes disclosure of an apparatus, wherein the channel extends from the upper part to the lower part.

The present disclosure includes disclosure of an apparatus, wherein the pump mechanism comprises a tube extending therefrom.

The present disclosure includes disclosure of an apparatus, wherein the upper part of the adapter body is configured to engage a distal end of the tube of the pump mechanism.

The present disclosure includes disclosure of an apparatus, configured to fit within an opening of a bottle that is configured to engage the pump mechanism.

The present disclosure includes disclosure of an apparatus, configured such that when the adapter body engages the tube of the pump mechanism, when the pump mechanism engages a bottle, and when the adapter body is positioned within the bottle, operation of the pump mechanism causes a liquid or paste product within the bottle to enter the channel of the adapter body, pass through the tube, and be expelled from the pump mechanism.

The present disclosure includes disclosure of an apparatus, wherein the liquid or paste product passes around at least some of the plurality of bristles prior to entering the channel of the adapter body.

The present disclosure includes disclosure of an apparatus, configured such that when the adapter body engages the tube of the pump mechanism, the adapter body and at least part of the tube can fit within an opening of a bottle having a liquid or paste product therein.

The present disclosure includes disclosure of an apparatus, configured such that when the adapter body engages the tube of the pump mechanism and when the adapter body is positioned within a bottle having a liquid or paste product therein, removal of the tube and the adapter body from the bottle allows a user to apply the liquid or paste product upon the bristles of the adapter body to skin of a person by brushing the liquid or paste product from the bristles to the skin.

The present disclosure includes disclosure of an apparatus, wherein the adapter body has a shape selected from the group consisting of cuboid, cylindrical, hexagonal prism, and cubic.

The present disclosure includes disclosure of an apparatus, wherein the upper part of the adapter body has a shape selected from the group consisting of rectangular, round, hexagonal, and square.

The present disclosure includes disclosure of an apparatus, wherein the adapter body comprises a proximal taper extending along a section of the adapter body between the upper part and the lower part.

The present disclosure includes disclosure of an apparatus, wherein the pump mechanism comprises a tube extending therefrom, and wherein a distal portion of the tube is configured to engage an opening of the channel at the upper part of the adapter body.

The present disclosure includes disclosure of an apparatus, comprising a silicone material.

The present disclosure includes disclosure of an apparatus, wherein the adapter body and the bristles comprise different materials.

The present disclosure includes disclosure of an apparatus, wherein the adapter body comprises a tube portion configured to directly engage the pump mechanism so that an additional tube is not required for operation of the pump mechanism.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a perspective view of an adapter, according to at least one embodiment of the present disclosure;

FIG. 2 shows a perspective view of an adapter coupled to a tube of a pump mechanism, according to at least one embodiment of the present disclosure;

FIG. 3 shows a perspective view of an adapter coupled to a tube of a pump mechanism and positioned within a bottle, according to at least one embodiment of the present disclosure;

FIG. 4 shows a perspective view of an adapter having a taper, according to at least one embodiment of the present disclosure;

FIG. 5 shows a perspective view of an adapter configured to be directly coupled to a pump mechanism without requiring an additional tube, according to at least one embodiment of the present disclosure; and

FIG. 6 shows perspective views of various adapter embodiments, according to various embodiments of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present invention is for a brush to apply moisturizers that is hollow in the middle. The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

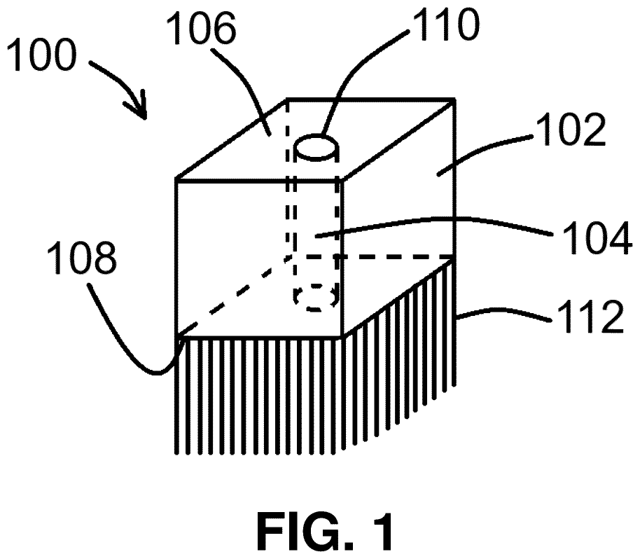

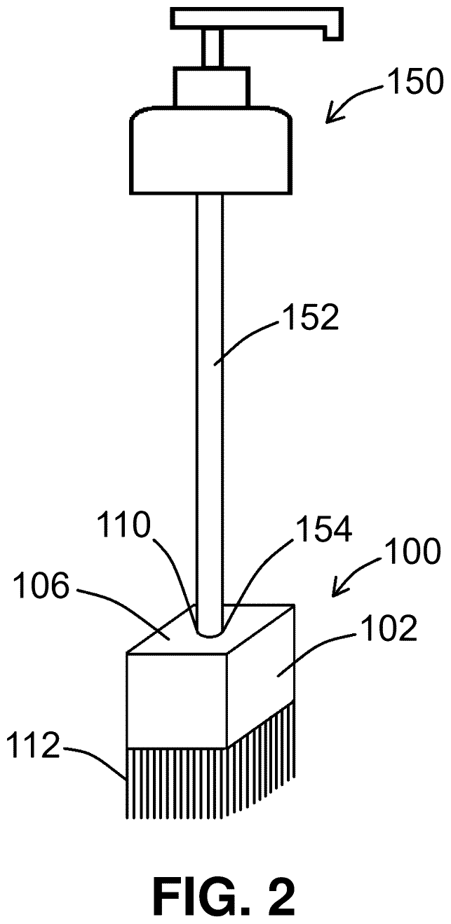

The present disclosure includes disclosure of an apparatus, such as shown in FIG. 1. As shown in FIG. 1, apparatus 100 comprises an adapter body 102 having a channel 104 defined therethrough from an upper part 106 of adapter body 102 to a lower part 108 of adapter body 102. Channel 104, at upper part 106 of adapter body, and in at least some embodiments, is configured to engage a portion of a tube 152 of a pump mechanism 150, such as shown in FIG. 2. A distal end 154 of tube 152, such as shown in FIG. 2, can be at least partially inserted into opening 110 of channel 104 at the upper part 106 of adapter body 102 so to effectively connect tube 152 to apparatus 100.

Adapter body 102 of apparatus 100, as shown in FIG. 1, also comprises a plurality of bristles 112 extending from lower part 108 of adapter body 102.

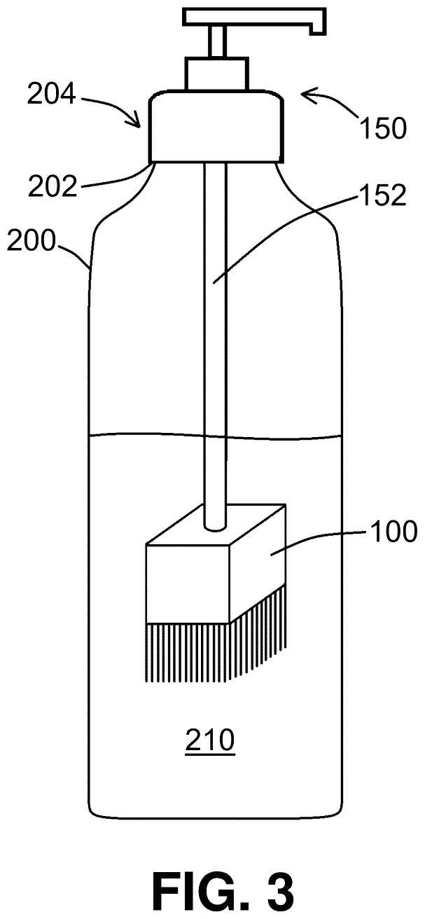

In practice, and when apparatus 100 is coupled to tube 152 of pump mechanism 150, apparatus 100, along with tube 152, can be inserted into an opening 202 of a bottle 200, such as shown in FIG. 3. As shown therein, pump mechanism 150 can couple to an upper portion 204 of bottle 200 so that apparatus 100 and tube 152 are within bottle 200.

When lotion 210 (or another liquid or paste product) is positioned within bottle 200 while pump mechanism 150 having tube 152 coupled thereto with an apparatus 100 coupled to said tube 152, pump mechanism 150 can be depressed so that a quantity of lotion or another product 210 can be expelled from pump mechanism 150. This allows a user, for example, to depress pump mechanism 150 so to receive a quantity of lotion 210 therefrom, so that the user can apply lotion 210 to his or her hands, for example. Quantities of lotion or other products 210 from inside bottle 200 can pass around bristles 112, proceed into channel 104 of adapter body 104, into tube 152, and out of pump mechanism 150.

In such an embodiment, a user can also decouple pump mechanism 150 from bottle 200 and withdraw tube 152 along with apparatus 100 therefrom. Bristles 112 can then have lotion or another product positioned thereon, and a user can hold pump mechanism 150 and effectively brush the lotion or other product 210 onto himself or herself, and/or can brush the lotion or other product 210 onto another person, such as a child or adult having potential sensitivities to touch from other people. When finished, the apparatus 100 and tube 152 of pump mechanism 150 can be reinserted into bottle 200, and pump mechanism 150 can be fastened to bottle 200 so that pump mechanism 150 can be depressed to expel lotion or other product 210 therefrom. As such, apparatus 100 embodiments of the present disclosure are sized and shaped to fit within an opening 202 of a bottle 200.

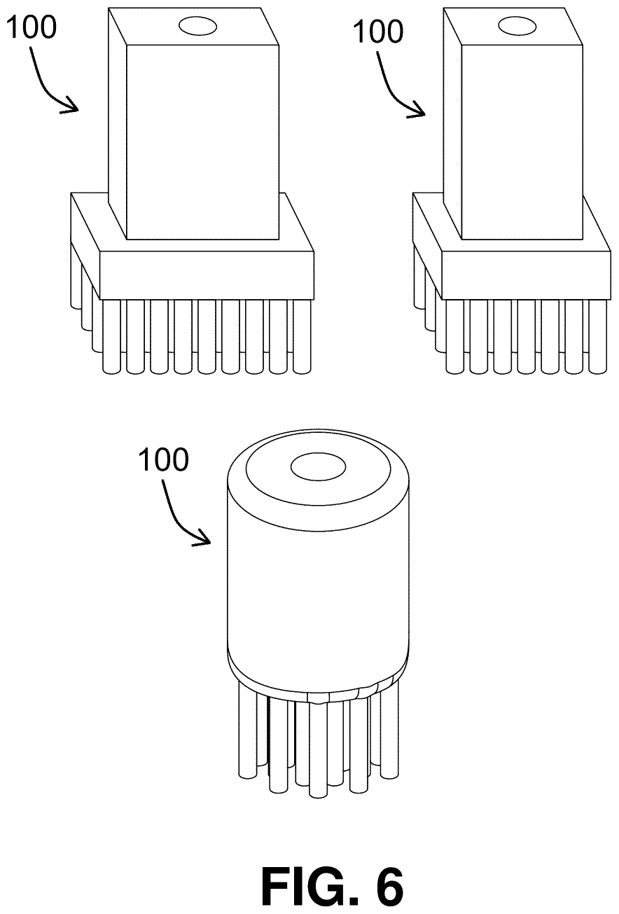

The end of the adapter body 102, where the bristles 112 are located, can take on various shapes, including but not limited to rectangular (cuboid), circular (cylindrical), hexagonal (a hexagonal prism), or squared (cubic) shapes. Various apparatus 100 embodiments are shown in FIG. 6. This design flexibility allows for customization based on user preference or specific application needs. The middle of the adapter body 102 is hollowed out (forming channel 104) to allow the lotion or other product to flow freely when the pump mechanism 150 is used.

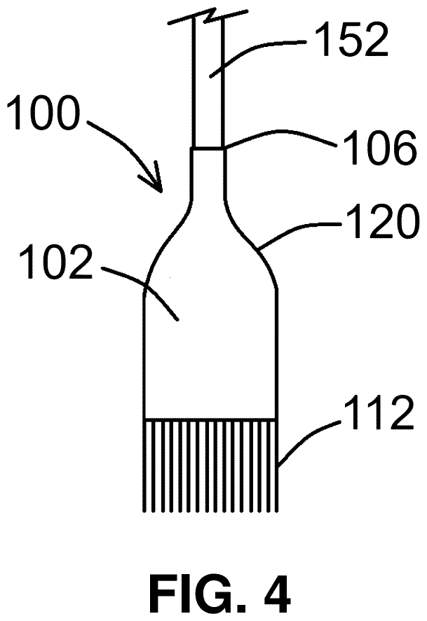

An additional embodiment of an apparatus 100 of the present disclosure is shown in FIG. 4. As shown therein, adapter body 102 comprises a proximal taper 120 extending between a section of a relatively widest portion of adapter body 102, along taper 120, to an upper part 106 of adapter body 102. Taper 120, in such an embodiment, forms part of the adapter body 102. Said taper 120 (also referred to as a shaft portion) is designed to fit over the bottom of the tube 152 of the pump mechanism 150, providing a secure and snug fit.

Exemplary apparatuses 100 of the present disclosure can comprise a silicone material. Silicone is a primary material that can be used in the construction of an apparatus 100 of the present disclosure. It is a versatile, hypoallergenic, and food-safe material, making it suitable for use in an application that involves contact with a child's skin. The apparatus 100 and its bristles 112 can be manufactured as a single piece of silicone, providing a seamless and durable design. The silicone can be dyed using a dye as may be desired. Alternatively, bristles 112 can be applied/coupled to an adapter body 102 such that the adapter body 102 and the bristles 112 comprise different materials, for example.

While silicone is the preferred material due to its hypoallergenic and food-safe properties, other materials could also be used to construct an apparatus 100 of the present disclosure. For instance, gelatine, plastics, and rubbers could be molded to form an apparatus 100 of the present disclosure. However, these materials may not offer the same level of safety, versatility, and comfort as silicone.

As for the bristles 112, alternatives such as nylon (synthetic) and natural bristles, such as hair/fur coming from various animals such as boars, hogs, badgers, squirrels, goats, horses, or oxen could be used. These materials can provide a different texture and feel when applying the lotion or other product 210, which may be preferred by some users. However, it should be noted that these materials would likely need to be attached to the adapter body 102 in a separate manufacturing step, as they cannot be molded as a single piece with the rest of the adapter body 102 like silicone.

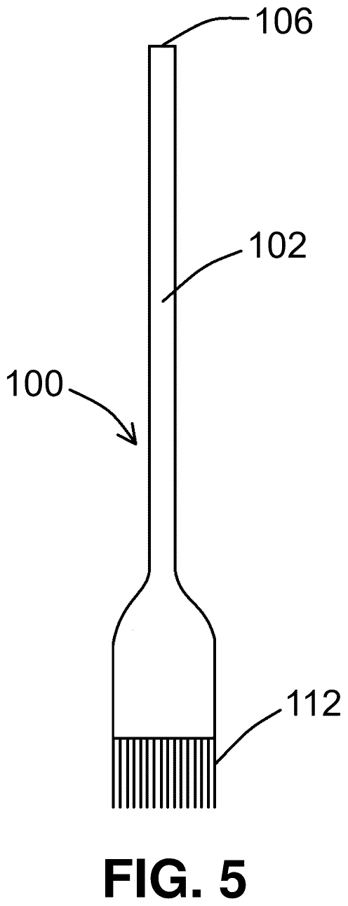

At least another embodiment of the present disclosure is shown in FIG. 5. As shown therein, apparatus 100 is configured for direct insertion into pump mechanism 150 such that a tube 152 is not required. In such an embodiment, apparatus 100 comprises an adapter body 102 defining a tube portion 140, whereby tube portion 140 is configured to fit within pump mechanism 150. Apparatus 100 would also comprise bristles 112 as referenced herein, and the channel 104 defined through adapter body 102 would be defined through the tube portion 140 as well. Such an embodiment would allow for the pump mechanism 150 to be operable as described herein, whereby pump mechanism 150 can be depressed (when coupled to a bottle 200 containing lotion or other product) to cause lotion or other product 210 to be expelled therefrom. Pump mechanism 150 can also then be removed from bottle 200 and held to brush lotion or other product 210 onto a body of a person via bristles 112 having lotion or other product 210 thereon.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

While various embodiments of devices and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. An apparatus, comprising:
an adapter body having an upper part, a lower part, and a channel defined therethrough;
wherein the upper part of the adapter body is configured to engage a pump mechanism; and
wherein a lower part of the adapter body comprises a plurality of bristles extending therefrom.

2. The apparatus of claim 1, wherein the channel extends from the upper part to the lower part.

3. The apparatus of claim 1, wherein the pump mechanism comprises a tube extending therefrom.

4. The apparatus of claim 3, wherein the upper part of the adapter body is configured to engage a distal end of the tube of the pump mechanism.

5. The apparatus of claim 1, configured to fit within an opening of a bottle that is configured to engage the pump mechanism.

6. The apparatus of claim 3, configured such that when the adapter body engages the tube of the pump mechanism, when the pump mechanism engages a bottle, and when the adapter body is positioned within the bottle, operation of the pump mechanism causes a liquid or paste product within the bottle to enter the channel of the adapter body, pass through the tube, and be expelled from the pump mechanism.

7. The apparatus of claim 6, wherein the liquid or paste product passes around at least some of the plurality of bristles prior to entering the channel of the adapter body.

8. The apparatus of claim 3, configured such that when the adapter body engages the tube of the pump mechanism, the adapter body and at least part of the tube can fit within an opening of a bottle having a liquid or paste product therein.

9. The apparatus of claim 3, configured such that when the adapter body engages the tube of the pump mechanism and when the adapter body is positioned within a bottle having a liquid or paste product therein, removal of the tube and the adapter body from the bottle allows a user to apply the liquid or paste product upon the bristles of the adapter body to skin of a person by brushing the liquid or paste product from the bristles to the skin.

10. The apparatus of claim 1, wherein the adapter body has a shape selected from the group consisting of cuboid, cylindrical, hexagonal prism, and cubic.

11. The apparatus of claim 1, wherein the upper part of the adapter body has a shape selected from the group consisting of rectangular, round, hexagonal, and square.

12. The apparatus of claim 1, wherein the adapter body comprises a proximal taper extending along a section of the adapter body between the upper part and the lower part.

13. The apparatus of claim 12, wherein the pump mechanism comprises a tube extending therefrom, and wherein a distal portion of the tube is configured to engage an opening of the channel at the upper part of the adapter body.

14. The apparatus of claim 1, comprising a silicone material.

15. The apparatus of claim 1, wherein the adapter body and the bristles comprise different materials.

16. The apparatus of claim 1, wherein the adapter body comprises a tube portion configured to directly engage the pump mechanism so that an additional tube is not required for operation of the pump mechanism.
